(19) United States
(12) Patent Application Publication
(10) Pub. No.: US 2004/0127161 A1
(43) Pub. Date: Jul. 1, 2004

(54) Mobile communication unit with self-diagnostic capability

(75) Inventors: Gustavo Leizerovich, Aventura, FL (US); David Graham, Gilbert, AZ (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/334,619

(22) Filed: Dec. 31, 2002

(51) Int. Cl. H04B 17/00

(52) U.S. Cl. 455/67.11; 455/115.1

(57) ABSTRACT

A method of diagnosing a subscriber unit 100. The method includes steps of generating a probe signal (412) at the subscriber unit (204), broadcasting the probe signal (412) from the subscriber unit (206), tuning a receiver (104) of the subscriber unit to receive the probe signal at the subscriber unit (208), establishing a signal metric for the probe signal (210) and determining whether the receiver (104) is functioning properly based upon the metric of the probe signal (218). In variations, the probe signal (412) includes several frequencies and a frequency generation unit (114) and a determination as to whether the frequency generation unit is operating properly is based upon whether the receiver 104 receives more than one of the several frequencies in the probe signal (220).

### TECHNICAL FIELD

This invention relates in general to mobile communication devices, and more particularly to methods of diagnosing mobile communication devices.

### BACKGROUND OF THE INVENTION

Mobile communication devices have become widespread in metropolitan areas throughout the world. There are a variety of types of mobile communication devices, but the most widely used are generally referred to as cell or cellular phones.

Occasionally, a subscriber radio, e.g., a cellular phone, is unable to receive clear messages, drops a substantial number of calls, or has other performance issues. When problems such as these arise, it is often difficult to determine whether it is the system infrastructure, e.g., base radio repeaters, site controllers and switching equipment, that is faulty or the subscriber radio. Furthermore, if the Subscriber radio is malfunctioning, it is difficult to determine what part of the subscriber radio is malfunctioning.

One component in subscriber radios that is subject to malfunction or failure is a receiver portion. To prevent communications from being garbled or lost altogether, the receiver must be sensitive enough to receive a range of signals having varying signal strength. Furthermore, the receiver must be able to tune across a band of frequencies in order to properly receive signals intended for the subscriber radio. A frequency generation unit (FGU) is often used to provide injection signals needed for a receiver to tune across a range of frequencies.

Additionally, most subscriber radios have a transmitter portion that must transmit at a particular frequency with sufficient power in order for a user to send receivable communications.

In many subscriber units, a Global Positioning Satellite (GPS) portion is utilized to receive signals from Global Positioning Satellites. The GPS signals allow the subscriber radio to obtain timing and location information that can be used by the radio, for example, to transmit its location in the event of an emergency.

Unfortunately, diagnosing problems with components such as these in a subscriber radio requires a user to take the subscriber radio to a trained specialist that has test equipment and the know-how to test these components. Thus, diagnosing problems with the subscriber unit is inconvenient and often prohibitively expensive.

### BRIEF DESCRIPTION OF THE DRAWINGS

FIG. 1 shows a subscriber unit with self diagnostic capability in accordance with one embodiment of the present invention;

FIG. 2 is a flow chart illustrating steps traversed by the subscriber unit when testing the FGU and receiver portion of FIG. 1 according to one embodiment of the present invention;

FIG. 3 is a flowchart illustrating steps traversed by the subscriber unit of FIG. 1 when diagnosing proper operability of the transmitter and GPS portions of FIG. 1 according to one embodiment of the present invention;

FIG. 4 is a functional block diagram illustrating an embodiment of a subscriber unit system architecture to carry out the self diagnostic steps of FIG. 2;

FIG. 5 is a is a functional block diagram illustrating another embodiment of a subscriber unit system architecture to carry out the self diagnostic steps of FIG. 3; and

FIG. 6 is an electrical block diagram of one embodiment of the probe signal generator of FIG. 1.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward.

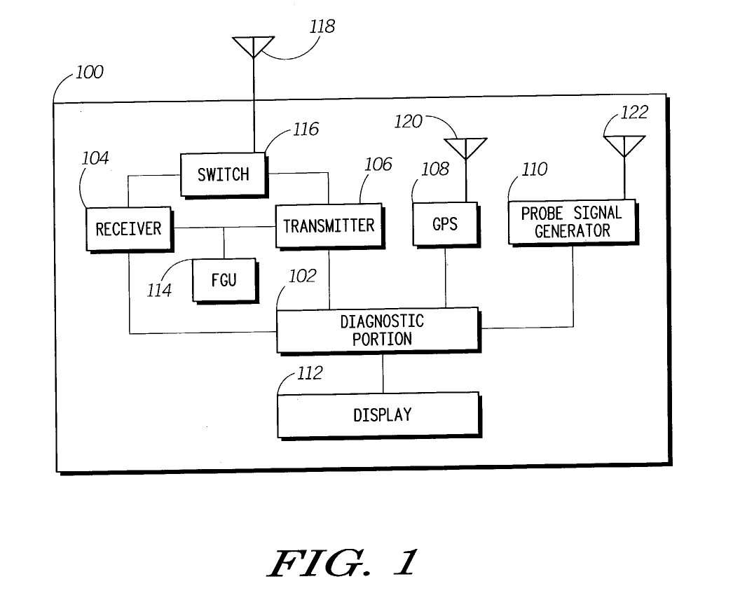

Referring first to FIG. 1, there is shown a block diagram of a subscriber unit 100 with self diagnostic capability in accordance with one embodiment of the present invention. Shown within the subscriber unit 100 are a diagnostic portion 102, and coupled to the diagnostic portion 102 are a receiver portion 104, a transmitter portion 106, a GPS portion 108, a probe signal generator 110, and a display 112. Also shown is a frequency generation unit (FGU) 114 coupled to the receiver portion 104 and the transmitter portion, and an antenna switch 116 is shown coupled to both the receiver portion 104 and the transmitter portion 106. A main antenna 118 is coupled to the antenna switch 116, a GPS antenna 120 is coupled to the GPS portion 108 and a probe antenna 122 is coupled to the probe signal generator 110.

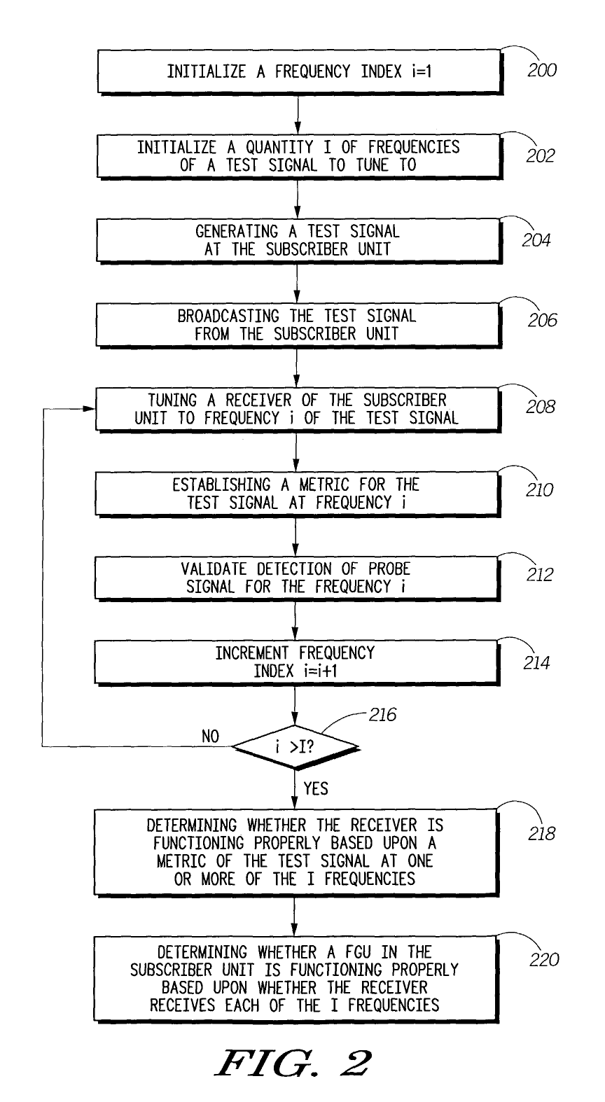

While referring to FIG. 1 reference will also be made to FIG. 2, which is a flow chart illustrating steps traversed by the subscriber unit 100 in testing the FGU 114 and receiver portion 104 according to one embodiment of the present invention.

In several embodiments, the subscriber unit 100 is a part of a communication system that utilizes a Time Division Multiple Access (TDMA) protocol according to Motorola's iDEN® communication system. This is certainly not required, however, and the present invention in several embodiments is applicable to subscriber units operating according to other communication protocols.

The diagnostic portion 102 in one embodiment generally functions to control the self diagnostic capabilities of the subscriber unit 100, and specifically, controls diagnostic operations to test the receiver portion 104, the transmitter portion 106, the GPS portion 108 and the FGU 114.

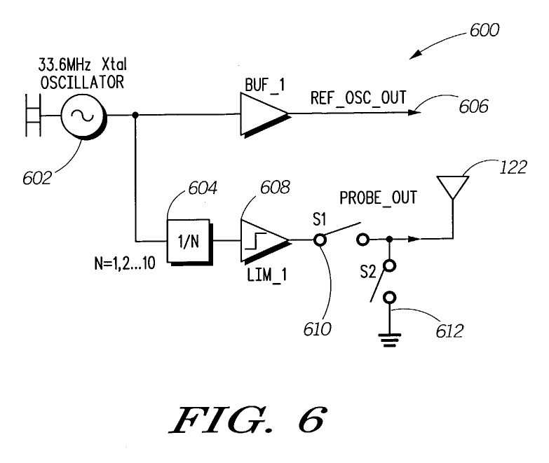

The probe signal generator 110 functions to provide, as part of the diagnostic operations, one or more probe signals to test the receiver 104, the GPS 108 and FGU 114 portions. As one of ordinary skill in the art recognizes, there are several different techniques to generate signals utilizing well-known hardware. For example, reference oscillators are generally present in subscriber radios, and in one embodiment, may be used with a phase lock loop to synthesize probe signals of varying frequencies. In another embodiment, as discussed further herein with reference to FIG. 6, a reference oscillator may be used to generate probe signals by generating harmonics of the reference oscillator frequency or another frequency generated from the reference oscillator frequency.

Advantageously, the diagnostic methods, according to several embodiments of the present invention, are carried out by the subscriber unit 100, and a user need not take time to bring the subscriber unit 100 to a service professional to perform several diagnostic tests. In one embodiment, for example, a user having performance problems with the subscriber unit 100 contacts a service center via telephone and the service center instructs the user to enter one or more keys on the subscriber unit to initiate a diagnostic procedure. In an alternative embodiment, initialization of the diagnostic methods disclosed herein are triggered remotely, e.g., through a base station, by a service center with a signal sent to the subscriber unit. Additionally, in some embodiments, the diagnostic procedures are initiated upon start up of the subscriber unit in much the same way as a computer performs tests on memory and other components when booted up.

Additionally, the self diagnostic procedure is easily implemented in the subscriber unit 100. The probe signal generator 110, for example, may be implemented in an existing integrated circuit, e.g., a power management IC or radio frequency IC, and only one pin of the host IC is needed for the probe antenna 122. The probe antenna 122, in one embodiment, is simply a trace added to an existing circuit board of the subscriber unit; however, the probe antenna 122 may be implemented by a variety of antenna types as one of ordinary skill in the art recognizes.

Once the diagnostic procedure is initiated, in some embodiments, the receiver and FGU portions 104, 114 are tested first. Initially, a frequency index, i is initialized to 1 (Step 200), and a quantity I of frequencies is initialized (Step 202) to, e.g., 3. The frequency index i is used to identify each frequency of a total number of frequencies I of a probe signal to attempt to receive at the receiver portion 104. The number of frequencies I may be one or more frequencies depending upon the subscriber unit and a level of diagnostic testing desired.

Next, when prompted by the diagnostic portion 102, the probe signal generator 110, in several embodiments, generates a probe signal within the subscriber unit (Step 204), and broadcasts the probe signal to the receiver portion 104 (Step 206). In some embodiments, the probe signal generator 110 produces the probe signal as several frequencies that are predetermined based upon frequencies the receiver is expected to receive during normal operation. In other words, the probe signal in some embodiments is propagated over several frequencies simultaneously, and many of the frequencies are within a normal range of the receiver's operation. In some embodiments, as discussed with reference to FIG. 6, a crystal oscillator present in the subscriber unit 100 is used to produce a fundamental frequency. The fundamental frequency that is converted to a square wave that is broadcast at Step 206 to produce several frequencies that are harmonics of the fundamental frequency.

In other embodiments, a probe signal may be synthesized at different frequencies by using other techniques including, but not limited to, a phase lock loop with a reference oscillator.

To test the receiver, the receiver is tuned to receive the probe signal at a frequency indexed by i (Step 208), and if the probe signal is detected by the receiver and diagnostic portions 104, 102 a metric for the received probe signal is established (Step 210). In one embodiment, the metric is received signal strength indicator (RSSI) metric. In some embodiments, to avoid picking up external signals with the main antenna 118, the antenna switch 116 is set to couple the main antenna 118 with the transmitter portion 106 when the receiver portion 104 is tuned to receive the probe signal.

In several embodiments, the detection of frequency i of the probe signal is validated to help ensure the received signal is indeed the probe signal sent from the probe signal generator 110 (Step 212). In some embodiments, one or more signatures are associated with the probe signal to validate that it is the probe signal that is received, and that the metric, e.g., the measured RSSI, is due to the probe signal generator 110, and not an external source.

In one embodiment, an RSSI measurement serves as a signature to validate that the received signal is the probe signal. For example, by measuring a noise floor RSSI when the probe signal generator 110 is not providing a probe signal, and measuring a RSSI of the probe signal when the probe signal generator 110 is broadcasting the probe signal, the RSSI of the received signal is compared with the noise floor RSSI. If the difference between the received probe signal's RSSI and the noise floor RSSI is sufficient, e.g., a 10 dB difference, then detection of the probe signal is validated because there is a sufficient likelihood that the received signal RSSI is from the probe signal and not an external source.

In another embodiment, a frequency offset signature is used to validate that the received signal is the probe signal. In this embodiment, the receiver is tuned, e.g., at Step 204, to a frequency slightly offset, e.g., 2 KHz, from a frequency of the probe signal. In this way, when the probe signal is properly received, the frequency offset will appear after the received probe signal is decoded by the diagnostic portion 102, which in several embodiments, comprises a digital signal processor. Thus, a presence of the frequency offset after the received probe signal is decoded validates that the received probe signal was indeed sent from the probe signal generator 110.

In yet another embodiment, a probe signal signature is created by prompting the probe signal generator 110 to turn the probe signal on and off in a defined pattern. Thus, detection of the probe signal is validated when the received probe signal appears and disappears at the receiver in accordance with the defined pattern.

After detection of the probe signal at frequency i is validated (Step 212), the frequency index i is incremented by one (Step 214), and if the frequency index i is not greater than the number of frequencies I to be monitored (Step 216), the receiver is again tuned to another frequency i and in some embodiments a metric is again established for the probe signal received at frequency i (Steps 208-210).

Then, based upon the metric of the probe signal, a determination is made whether the receiver is functioning properly (Step 208). In some embodiments, the metric is a received signal strength indicator (RSSI), and the sensitivity of the receiver is checked by verifying the RSSI of the received probe signal is within an expected range for the receiver portion's design. It should be recognized that while Step 210 is shown being carried out for every frequency up to I frequencies, that the sensitivity of the receiver in some embodiments is tested by taking an RSSI of only one of the frequencies.

When the probe signal is generated as several frequencies, the FGU 114 of the subscriber unit is tested by the ability of the receiver portion 104 to receive different frequencies of the probe signal. Thus, a determination is made whether the FGU 114 is functioning properly based upon whether the receiver is able to tune to each of the I frequencies (Step 220). In some embodiments, if a frequency of the probe signal that should be received is not received at Step 208, then the diagnostic procedure is halted and an error message is generated that may be displayed at the display 112 and/or transmitted to a system operator.

In other embodiments, the diagnostic portion 102 continues to implement the loop shown as Steps 208 through 216 even if the receiver portion 104 is not able to tune to one of the frequencies of the probe signal, and the failure of the receiver portion 104 at that frequency is stored in a memory. A report for each frequency may then be retrieved from the memory at the display 112 and/or retrieved remotely by the system operator.

Referring next to FIG. 3, shown is a flowchart illustrating steps traversed by the subscriber unit of FIG. 1 when diagnosing proper operability of the transmitter and GPS portions 106, 108 of FIG. 1 according to one embodiment of the present invention. In other embodiments, however, the GPS portion 108 is not required at all, and hence, in these other embodiments the following diagnostic procedures for testing the GPS portion 108 are not carried out.

In several embodiments, to test both the transmitter portion 106 and the GPS portion 108, a second probe signal is broadcasted by the transmitter (Step 300). In some embodiments, the transmitter is able to broadcast frequencies that fall within a receiving band of the GPS portion 108. For example, the transmitter portion 106 in some embodiments may be designed to transmit at a receiving band of the GPS portion 108 or in other embodiments, a harmonic of a primary frequency transmitted by the transmitter portion 106 falls within the receiving band of the GPS portion 108.

In yet other embodiments, the transmitter portion 106 is neither capable of transmitting a primary frequency that falls within the receiving band of the GPS portion 108 nor has a harmonic that falls within the receiving band of the GPS portion 108. To produce a signal detectable by the GPS portion 108 when the transmitter alone is not designed to do so, in one embodiment, a supplemental signal from the probe signal generator 110 is broadcast to mix with the second probe signal from the transmitter portion to produce a mixed signal that is detectable by the GPS portion 108, i.e., the mixed signal falls within a receiving band of the GPS portion 108.

After the second probe signal is transmitted, if the GPS portion 108 detects the second probe signal (302), then both the transmitter and the GPS portion 108 pass the diagnostic test (Step 304), and the diagnostic procedure is ended (Step 314). It is noted that, when a supplemental signal is required, the GPS portion 108 will not be able to detect the mixed signal (comprising the second probe signal and the supplemental signal) when the transmitter portion 106 is not operating properly.

If the second probe signal is not detected (Step 302), whether supplemented or not, then either the transmitter is not operating properly or the GPS portion 108 is not operating properly. To help resolve the uncertainty, in one embodiment, a third probe signal is produced by the probe signal generator 110 that falls within the receiving band of the GPS portion 108 (Step 306). As one of ordinary skill in the art recognizes, generating a frequency within a receiving band may done several ways. For, example, in one embodiment discussed further with respect to FIG. 6, harmonics of a reference signal that fall within the receiving band are produced by the probe signal generator 110.

If the third probe signal is not detected by the GPS portion 108 (Step 308), then it is likely that the GPS portion 108 is not operating properly (Step 310) and the diagnostic procedure is ended (Step 314). If, however, the GPS portion 108 does receive the third probe signal from the signal probe generator, then it is likely that the transmitter portion 106 is not operating properly (Step 312), and the diagnostic procedure is then ended (Step 314).

In several embodiments, receipt of the second and/or third probe signals is distinguished from receipt of an external signal by a signature that is associated with the signal(s). For example, in one embodiment, the second and/or third probe signals are turned on and off by the transmitter portion 106 and the probe signal generator 110 respectively to provide a signature pattern that the GPS portion 108 recognizes. In another embodiment, a difference between an RSSI of the second and/or third signals and a noise floor RSSI, provides a signature for the second and/or third probe signals in a similar fashion as was described for the first probe signal with reference to FIGS. 1 and 2.

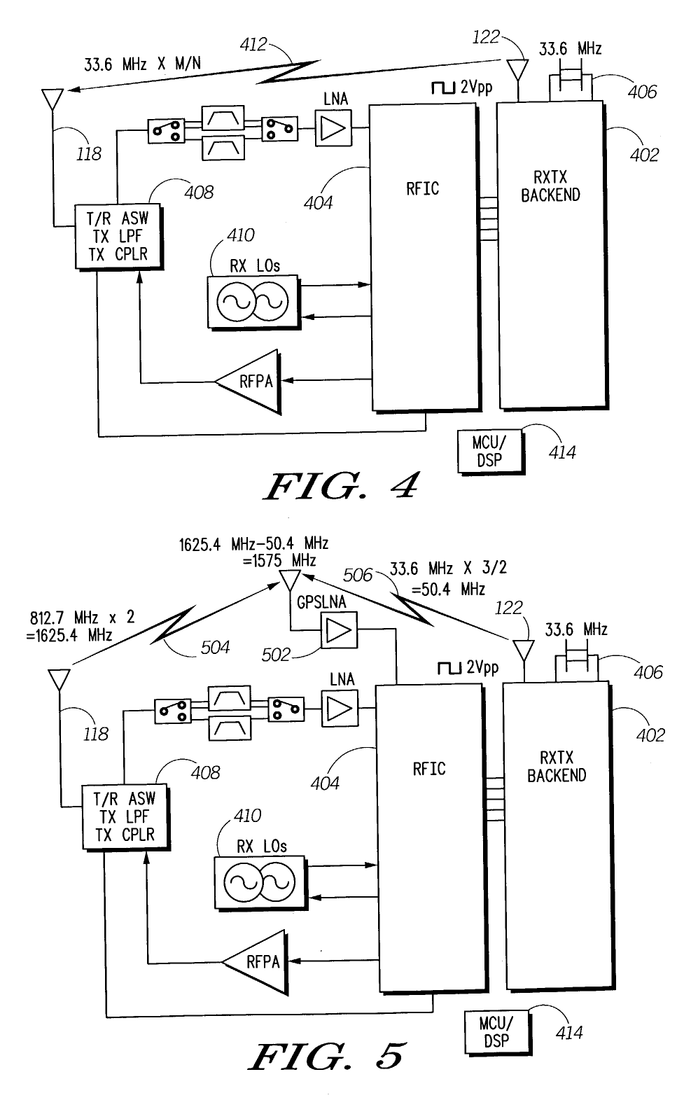

Referring next to FIG. 4, shown is a functional block diagram illustrating an embodiment of a subscriber unit system architecture to carry out the self diagnostic steps of FIG. 2. Shown are a RXTX Backend IC 402 coupled to a radio frequency integrated circuit (RFIC) 404, the probe antenna 122 and an oscillator 406. The RFIC 404 is also coupled to a transceiver portion 408 and a receiver local oscillator portion (RXLO) 410. A probe signal 412 is shown between the probe antenna 122 and the main antenna 118, and the main antenna 118 is shown coupled to the transceiver portion 408. A microcontroller and digital signal processor unit (MCU/DSP) 414 is coupled to the RXTX Backend IC 402, the RFIC 404 and the transceiver portion 408 by connections not shown.

The receiver portion 104 in this embodiment is implemented at least in part by the transceiver portion 408 and the RFIC 404, and the FGU 114 is implemented in part by the RXLO portion 410 and the RFIC 404. Additionally, the functions carried out by the diagnostic portion 102 are carried out by the MCU/DSP 414 which carries out instructions encoded in firmware, as is known to one of ordinary skill in the art, to carry out the steps described with reference to FIG. 2. The probe signal generator 110 is implemented in the RXTX Backend IC 402, and the probe antenna 122 is coupled to the RXTX Backend IC 402 and broadcasts the probe signal 412 to the main antenna 118. This particular configuration is certainly not required, however, and the probe signal generator 110 could be located in other integrated circuits in a subscriber unit including, but not limited to, the RFIC 404.

Referring next to FIG. 5, shown is a combination functional block and hardware diagram illustrating one embodiment to implement the diagnostic portion 102 and probe signal generator 110 of FIG. 1 to carry out the steps described with reference to FIG. 3 to diagnose a transmitter portion, e.g., the transmitter portion 106, and a GPS portion, e.g., the GPS portion 108, of a subscriber unit.

The hardware in FIG. 5 includes substantially the same components that are coupled in substantially the same way as FIG. 4 except that in FIG. 5, the first probe signal 412 is not shown and there is additionally shown a GPS low noise amplifier (LNA) 502 that couples the GPS antenna 120 to the RFIC 404. Additionally, the transceiver portion 408 is shown broadcasting a second probe signal 504 from the main antenna 118 to the GPS antenna 120 and the probe antenna 122 is shown broadcasting a supplemental signal 506 to the GPS antenna 120.

The transmitter portion 106 of FIG. 1, in the present embodiment, is implemented in part by the transceiver portion 408 and the RFIC portion 404 and is designed to transmit at a main frequency of 812.7 MHz. When transmitting at this frequency, a second order harmonic is produced and transmitted at 1625.4 MHz, and in this embodiment, the GPS receiver is designed to receive a 1575 MHz frequency. Thus, the transmitter in the present embodiment is supplemented by the supplemental signal 506 having a frequency of 50.4 MHz to produce a mixed product of the second probe signal 504 and the supplemental signal 506 at 1575 MHz.

In some embodiments, the second probe signal 504 and the supplemental signal 506 mix in the GPS low noise amplifier 502. In one embodiment, the GPS low noise amplifier 502 is switched to a non-linear operating mode to facilitate mixing of the second probe signal 504 and the supplemental signal 506.

In one embodiment, a probe signal generator 110 produces the supplemental signal 506 by synthesizing the supplemental signal 506 with a phase lock loop fed by a reference oscillator, e.g., oscillator 406. In other embodiments, as described with reference to FIG. 6, the supplemental signal is provided by a harmonic of a reference signal, for example, a reference signal produced from the oscillator 406.

Referring to FIG. 6, shown is an electrical block diagram of one embodiment of the probe signal generator 110 of FIG. 1. Shown is an oscillator 602, a divider 604, a reference signal output 606, a limiter 608, a probe antenna switch 610, an antenna to ground switch 612 and the probe antenna 122.

In several embodiments, the oscillator 602 is a crystal oscillator that drives normal radio operation, for example, the receiver and transmitter portions 104, 106, via the reference output, with a sine wave frequency of 33.6 MHz. One of ordinary skill in the art recognizes that other oscillator frequencies may be used, including 16.8 MHz and 26 MHz oscillators, without departing from the scope of the present invention. It is noted that yet other oscillator frequencies may be preferred over those enumerated based upon a frequency that is desired to be produced.

It should also be noted that the oscillator 602 is not limited to a crystal oscillator, and that other elements in the subscriber radio that generate a frequency, e.g., a phase lock loop, can be used to generate the probe signal.

In operation, the divider 604 receives the 33.6 MHz sine wave and reduces the frequency to another frequency by dividing the 33.6 MHz frequency by an integer N that, in some embodiments, is less than 10. The reduced frequency, e.g., 33.6 MHz/N, also referred to herein as a fundamental frequency, is received by the limiter 608 and is converted to a square wave with a frequency equal to the known frequency of the oscillator, e.g., 33.6 MHz, divided by N. In some embodiments, the square wave is implemented as a rail-to-rail signal with fast edges. The conversion from the sine wave at the fundamental frequency, e.g., 33.6 MHz/N, to the square wave produces several harmonics that are each identified by an order M of the fundamental frequency. When the probe antenna switch 610 is closed, the harmonics are radiated by the probe antenna 122.

Advantageously, the probe signal generator 600 simultaneously produces a multitude of frequencies, i.e., a probe signal, which may be used to test a receiver over a specific band without having to add an additional oscillator or produce one individual frequency after another.

In some embodiments, M and N are chosen to produce a probe signal with harmonics that are near one or both edges of the receiver's operating band. In one embodiment, for example, a probe signal to test a receiver designed to operate over a band between 851 and 870 MHz is generated by setting the integer N to 3; thus producing a fundamental frequency of 11.2 MHz that is received by the limiter 604. After the limiter 604 converts the 11.2 MHz fundamental frequency to a square wave, harmonics of the fundamental frequency are produced. The harmonics of the 11.6 MHz fundamental frequency include a harmonic of order 76 (i.e, M=76) at 851.2 MHz and a harmonic of order 77 (i.e., M=77) at 862.4 MHz. Thus, in the present embodiment, a probe signal comprising frequencies of both 851.2 MHz and 862.4 MHz is produced and the frequencies fall within the band the receiver is expected to operate over, i.e., the 851 to 870 MHz band.

Beneficially, in this example, the frequencies of the probe signal span 11.2 MHz of the receiver's operating band, and thus, provide a substantial range over which VCO lock operation of a main PLL in a FGU, e.g., the FGU 114, in a subscriber unit may be tested.

It is noted that the values of N may be varied to produce a probe signal with a greater or lesser number of harmonics that fall within a receiver's operating band. For example, when N is selected to be equal to 6, harmonics of 935.2 MHz (M=167) and 940.8 MHz (M=168) are produced that are viable probe signals for a receiver with an operating band between 935 and 941 MHz.

Thus, in some embodiments, the probe signal generator 600 performs Steps 204 and 206 of FIG. 2 when prompted by the diagnostic portion 102, which in some embodiments is implemented by the MCU/DSP of FIG. 4.

When the probe signal generator 600 is not operating, the probe antenna switch 610 is opened and the antenna to ground switch 612 is closed to prevent any stray (and potentially interfering) signals from radiating from the probe antenna 122.

Beneficially, the probe signal generator 600 easily adapts to provide a supplemental signal, e.g., the supplemental signal 506, to test a GPS receiver of a subscriber unit, e.g., the GPS portion 108.

In one embodiment, for example, a transmitter with a carrier transmit frequency of 812.7 MHz produces a second probe signal at 1625.4 MHz, i.e., a second harmonic of the 812.7 MHz signal. Preferably, when the transmitter is prompted, e.g., by the MCU/DSP 414, to transmit the second probe signal, the transmitter power is cutback by, for example, 40 dB (−12 dBm) to prevent damaging a front end of the GPS receiver.

Typically, GPS receivers are only able to detect signals that are close to 1575 MHz. Thus, when a 1625.4 MHz probe signal is provided by the transmitter, e.g., the transmitter portion 106, a supplemental signal from the probe signal generator 600 of approximately 50.4 MHz is required to produce a 1575 MHz signal. In the present embodiment, a 50.4 MHz signal is produced by setting the divider ratio N to 2 to produce a 50.4 MHz signal at a third harmonic of the divided frequency, i.e., 3×(33.6 MHz/2)=50.4 MHz. A mixing product will occur in the GPS receiver, e.g., in the LNA 502, at 1625.4 MHz−50.4 MHz=1575 MHz.

If the GPS receiver, e.g., the GPS portion 108, detects the mixed signal, then it is likely an LNA, e.g., LNA 502, of the GPS receiver is functioning. In many embodiments, a signature is associated with the mixed signal by turning off and on the second probe signal and/or the supplemental signal from the transmitter and probe signal generator 600 respectively. The signal received at the GPS receiver is then validated as the mixed signal as opposed to an external signal.

While the invention herein disclosed has been described by means of specific embodiments and applications thereof, numerous modifications and variations could be made thereto by those skilled in the art without departing from the scope of the invention set forth in the claims.

What is claimed is:

1. A method of diagnosing a subscriber unit, comprising:
generating a probe signal at the subscriber unit;
broadcasting the probe signal from the subscriber unit;
tuning a receiver of the subscriber unit to receive the probe signal at the subscriber unit;
determining whether the receiver is functioning properly based upon detection of the probe signal at the receiver.

2. The method of claim 1, further comprising the step of:
determining whether a frequency generation unit in the subscriber unit is functioning properly based upon whether the receiver receives a plurality of frequencies wherein the plurality of frequencies comprises a portion of the probe signal;
wherein the step of generating the probe signal comprises generating the probe signal as a multiplicity of frequencies,
wherein the step of broadcasting comprises broadcasting the probe signal as the multiplicity of frequencies, wherein the multiplicity of frequencies comprises the plurality of frequencies;
wherein the step of tuning the receiver of the subscriber unit to receive the probe signal comprises tuning the receiver to receive each of the plurality of frequencies.

3. The method of claim 2, further comprising the step of:
generating a fundamental frequency at the subscriber unit;
wherein the step of generating the probe signal comprises generating harmonics of the fundamental frequency;
wherein each of the plurality of frequencies and each of the multiplicity of frequencies are a harmonic of the fundamental frequency.

4. The method of claim 1, further comprising the step of:
establishing a received signal strength metric of the probe signal;
wherein the step of determining whether the receiver is functioning properly based upon receipt of the probe signal comprises determining whether the receiver is functioning properly based upon the received signal strength metric.

5. The method of claim 1, further comprising the step of:
determining whether a signature pattern is present in the probe signal; and
validating the detection of the probe signal at the receiver in response to the signature pattern being present in the probe signal.

6. The method of claim 1, further comprising the steps of:
determining a background received signal strength when the probe signal is not broadcast;
comparing the received signal strength metric of the probe signal with the background received signal strength to establish a difference between the received signal strength metric of the probe signal and the background received signal strength; and
validating the detection of the probe signal at the receiver in response to a magnitude of the difference between the received signal strength metric of the first probe signal and the background received signal strength exceeding a threshold.

7. The method of claim 1, further comprising:
generating a second probe signal at the subscriber unit;
broadcasting the second probe signal from a transmitter of the subscriber unit;
receiving the second probe signal at a GPS portion of the subscriber unit;
determining whether the GPS portion is functioning properly based in part upon detection of the second probe signal.

8. The method of claim 7, further comprising:
generating a third probe signal at the subscriber unit;
broadcasting the third probe signal from a probe signal generator;
determining whether the transmitter is functioning properly based upon whether the third probe signal is received at the GPS portion.

9. The method of claim 7, further comprising:
generating a supplemental signal at the subscriber unit;
mixing the second probe signal and the supplemental signal to create a mixed signal;
wherein the step of determining whether the GPS portion is functioning properly comprises determining whether the GPS portion is functioning properly based upon detection of the mixed signal at the GPS portion.

10. A subscriber radio comprising:
probe signal generator to generate a probe signal;
a probe antenna configured to broadcast the probe signal;
a diagnostic portion coupled to the probe signal generator wherein the diagnostic portion triggers the probe signal generator to send the probe signal;
a receiver portion coupled to the diagnostic portion; and
a transceiver antenna to receive the probe signal;
wherein operability of the receiver portion is determined in part by whether the receiver portion receives the probe signal.

11. The subscriber radio of claim 10, further comprising:
a phase lock loop coupled to the receiver portion to tune the receiver portion;
wherein the probe signal generator comprises a harmonic signal generator to produce harmonics of a frequency, wherein the probe signal comprises the harmonics;
wherein operability of the phase lock loop is determined in part by whether the receiver portion is able to receive a plurality of the harmonics.

12. The subscriber radio of claim 10, further comprising:
a global positioning portion coupled to the diagnostic portion;
a global positioning antenna coupled to the global positioning portion;
wherein operability of the global positioning portion is determined in part by whether the global positioning portion receives a second probe signal from a transmitter portion.

13. The subscriber radio of claim 12, wherein the global positioning portion comprises a product mixer configured to mix the second probe signal transmitted from the transmitter portion with a supplemental probe signal from the probe signal generator to produce a product probe signal wherein operability of the global positioning portion is determined by whether the global positioning portion receives the product probe signal.

14. A subscriber radio comprising:
means for generating a probe signal at the subscriber unit;
means for broadcasting the probe signal from the subscriber unit;
means for tuning a receiver of the subscriber unit to receive the probe signal at the subscriber unit;
means for determining whether the receiver is functioning properly based upon detection of the probe signal at the receiver.

15. The subscriber radio of claim 14, further comprising:
means for determining whether a frequency generation unit in the subscriber unit is functioning properly based upon whether the receiver receives a plurality of frequencies wherein the plurality of frequencies comprises a portion of the probe signal;
wherein the means for generating the probe signal comprises means for generating the probe signal as a multiplicity of frequencies,
wherein the means for broadcasting comprises means for broadcasting the probe signal as the multiplicity of frequencies, wherein the multiplicity of frequencies comprises the plurality of frequencies;
wherein the means for tuning the receiver of the subscriber unit to receive the probe signal comprises means for tuning the receiver to receive each of the plurality of frequencies.

16. The subscriber radio of claim 15, further comprising:
means for generating a fundamental frequency at the subscriber unit;
wherein the means for generating the probe signal comprises means for generating harmonics of the fundamental frequency;
wherein each of the plurality of frequencies and each of the multiplicity of frequencies are a harmonic of the fundamental frequency.

17. The subscriber radio of claim 14, further comprising:
means for establishing a received signal strength metric of the probe signal;
wherein the means for determining whether the receiver is functioning properly based upon receipt of the probe signal comprises means for determining whether the receiver is functioning properly based upon the received signal strength metric.

18. The subscriber radio of claim 14, further comprising:
means for determining whether a signature pattern is present in the probe signal; and
means for validating the detection of the probe signal at the receiver in response to the signature pattern being present in the probe signal.

19. The subscriber radio of claim 14, further comprising:
means for generating a second probe signal at the subscriber unit;
means for broadcasting the second probe signal from a transmitter of the subscriber unit;
means for receiving the second probe signal at a GPS portion of the subscriber unit;
means for determining whether the GPS portion is functioning properly based in part upon detection of the second probe signal.

20. The subscriber radio of claim 19, further comprising:
means for generating a third probe signal at the subscriber unit;
means for broadcasting the third probe signal from a probe signal generator;
means for determining whether the transmitter is functioning properly based upon whether the third probe signal is received at the GPS portion.
